(19) United States
(12) Patent Application Publication
(10) Pub. No.: US 2016/0122008 A1
(43) Pub. Date: May 5, 2016

(54) Roller Traction Drive System for an Aircraft Drive Wheel Drive System

(71) Applicant: Borealis Technical Limited, North Plains, OR (US)

(72) Inventors: Isaiah W. Cox, London (GB); Scott Perkins, Kent, WA (US); David Stoltze, Warren, MI (US)

(21) Appl. No.: 14/531,359

(22) Filed: Nov. 3, 2014

(51) Int. Cl. B64C 25/40

(52) U.S. Cl. CPC B64C 25/405

(57) ABSTRACT

A roller traction drive system integral with a non-engine drive means and a clutch assembly in an aircraft drive wheel drive system capable of moving an aircraft autonomously on the ground is provided. The roller traction drive system is selectively activated by the clutch assembly into and out of actuating contact with the non-engine drive means to drive the aircraft drive wheel. Roller traction drive system components are made of materials designed to enable dry running and operation at the torques, drive means speeds, and reduction ratios required to actuate a drive means and drive a drive wheel for autonomous aircraft ground movement. Roller traction drive materials may be selected to maintain effective torque transfer between roller traction drive system components and the non-engine drive means as well as to minimize undesirable thermal expansion.

### TECHNICAL FIELD

The present invention relates generally to roller traction drive systems and particularly to a roller traction drive system designed to actuate a non-engine drive means in an aircraft drive wheel drive system to move an aircraft autonomously during ground operations without use of the aircraft's main engines or external tow vehicles.

### BACKGROUND OF THE INVENTION

As air travel has increased over the past decades, airport facilities have become more crowded and congested. Minimizing the time between the arrival of an aircraft and its departure to maintain an airline's flight schedule, and also to make a gate or parking location available without delay to an incoming aircraft, has become a high priority in the management of airport ground operations. The safe and efficient ground movement of a large number of aircraft simultaneously into and out of ramp and gate areas has become increasingly important. As airline fuel costs, safety concerns, and regulations have increased, the airline industry is beginning to acknowledge that continuing to use an aircraft's main engines to move aircraft during ground operations is no longer the best option. The delays, costs, and other challenges to timely and efficient aircraft pushback from airport terminals associated with the use of tugs and tow vehicles makes this type of aircraft ground movement an unattractive alternative to the use of an aircraft's main engines to move an aircraft on the ground. Restricted use of an aircraft's engines on low power during arrival at or departure from a gate is an additional, although problematic, option. Not only does such engine use consume fuel, it is also burns fuel inefficiently and produces engine exhaust that contains microparticles and other products of incomplete combustion. Operating aircraft engines, moreover, are noisy, and the associated safety hazards of jet blast and engine ingestion in congested gate and ramp areas are significant concerns that cannot be overlooked.

The use of a drive means, such as a motor structure, integrally mounted with a wheel to rotate the wheel an aircraft has been proposed. The use of such a structure should move an aircraft independently and efficiently on the ground without reliance on the aircraft's main engines. U.S. Pat. No. 7,445,178 to McCoskey et al, for example, describes electric nose wheel drive motors intended to drive aircraft during taxi. U.S. Pat. No. 7,469,858 to Edelson; U.S. Pat. No. 7,891,609 to Cox; U.S. Pat. No. 7,975,960 to Cox; U.S. Pat. No. 8,109,463 to Cox et al; and British Patent No. 2457144, owned in common with the present invention, additionally describe aircraft drive systems that use electric drive motors to power aircraft wheels and move an aircraft on the ground without reliance on aircraft main engines or external vehicles. While the drive means described in these patents can effectively move an aircraft autonomously during ground operations, it is not suggested that the drive means could be driven or actuated by roller-type or like drive systems. None of the foregoing art, moreover, recognizes the significant improvements in drive means operating efficiency possible when gearing systems are replaced by roller-type drive systems to drive or actuate non-engine drive means that move aircraft during ground operations.

The drive means currently proposed to drive aircraft on the ground typically rely on gearing systems that operate with the drive means to drive an aircraft wheel and, thus, the aircraft. While gear systems can be used quite effectively with such drive systems, they require proper lubrication and may add undesirable weight to an aircraft wheel. The use of traction drives or roller gear drives to replace conventional gear systems has been suggested, although these traction drives, such as those described in U.S. Pat. No. 4,617,838 to Anderson, available from Nastec, Inc. of Cleveland, Ohio, typically rely on ball bearings. Using rollers in place of the balls and adapting roller gear or traction drive systems to replace gearing and/or gear systems in an aircraft drive wheel to actuate drive means that independently drive an aircraft drive wheel on the ground has not been suggested.

A need exists, therefore, for a highly efficient roller traction drive system that can be effectively integrated with a non-engine drive means actuated by the roller traction drive system in a an aircraft drive wheel drive system that moves the aircraft autonomously on the ground without reliance on the aircraft's main engines or external ground vehicles

### SUMMARY OF THE INVENTION

It is a primary object of the present invention, therefore, to provide a highly efficient roller traction drive system that can be effectively integrated with a non-engine drive means actuated by the roller traction drive system in a an aircraft drive wheel drive system that moves the aircraft autonomously on the ground without reliance on the aircraft's main engines or external ground vehicles

It is another object of the present invention to provide a roller traction drive system for actuating an aircraft drive wheel non-engine drive means that has a lightweight, compact design and is configured to support the drive means within the space available in an aircraft wheel.

It is an additional object of the present invention to provide a roller traction drive system for an aircraft drive wheel drive system with components made of materials selected to ensure and maintain effective torque transfer between the roller traction drive system and a non-engine drive means in the drive system.

It is a further object of the present invention to provide a roller traction drive system integrated with an aircraft drive wheel drive system that is made of materials selected to achieve operating torques, speeds, and reduction ratios required to actuate a non-engine drive means to drive the aircraft drive wheel and move the aircraft autonomously on the ground.

It is yet a further object to provide a roller traction drive system integral with an aircraft drive wheel drive system designed and formed of materials selected to maintain traction pressure required to drive a non-engine drive means powering an aircraft drive wheel below a selected endurance limit.

It is yet another object of the present invention to provide a roller traction drive system integral with an aircraft drive wheel drive system made of a combination of materials selected to prevent the preload required to effectively transfer torque from being lost.

The aforesaid objects are achieved by providing a roller traction drive system integral with an aircraft drive wheel drive system capable of moving an aircraft on the ground without reliance on the aircraft's main engines or external ground vehicles. The preferred aircraft drive wheel drive system includes non-engine drive means, preferably including a rotating element and a stationary element capable of achieving high operating speeds, an automatically or manually operable clutch assembly, and a roller traction drive system operatively interposed between the drive means and the clutch assembly to enable the clutch assembly to be selectively engaged and disengage to move the roller traction drive system into and out of actuating contact with the non-engine drive means. The roller traction drive system includes dry running components designed to safely and effectively operate at the torques, drive means speeds, and reduction ratios required to actuate a high speed drive means and, therefore, to drive a drive wheel on which the system is mounted to move an aircraft independently on the ground. The roller traction drive system components are made of materials selected to ensure and maintain effective torque transfer between the roller traction drive system and the drive means, as well as to minimize undesirable thermal expansion of roller traction drive system components.

Other objects and advantages will be apparent from the following description, claims, and drawings.

### BRIEF DESCRIPTION OF THE DRAWINGS

FIG. 1 is a cross-sectional perspective schematic view of a portion of an aircraft landing gear and a landing gear drive wheel on which aircraft drive wheel drive system with a roller traction drive system of the present invention is mounted;

FIG. 2 is a diagrammatic view of a portion of an aircraft drive wheel system showing the roller traction drive system of the present invention and its location relative to a drive means and a clutch assembly within a space in the aircraft drive wheel defined to hold these system components;

FIG. 3 is a schematic representation of a perspective view of one possible arrangement of rollers in a roller traction drive system of the present invention; and

FIG. 4 is a diagrammatic representation of an end view of another arrangement of components of the present roller traction drive system.

### DESCRIPTION OF THE INVENTION

The benefits of being able to efficiently and safely move an aircraft during ground operations without reliance on the aircraft's main engines or external vehicles have long been recognized. Actually achieving these benefits, however, has proved challenging. Applicant's previously proposed aircraft wheel non-engine drive means have been demonstrated to effectively power drive wheels and move aircraft on the ground and, thus, can enable aircraft operators to achieve the advantages of autonomous ground movement. The present invention improves the capabilities of Applicant's original aircraft drive wheel drive system and expands the advantages possible when aircraft can be driven during ground operations by controllable onboard drive means independently of the aircraft's main engines and external ground vehicles. These advantages and improvements are achieved, in large part, by the design of an aircraft drive wheel drive system which integrally incorporates a roller traction drive system designed to establish and maintain torque transferring control of the operation of a drive wheel non-engine drive means.

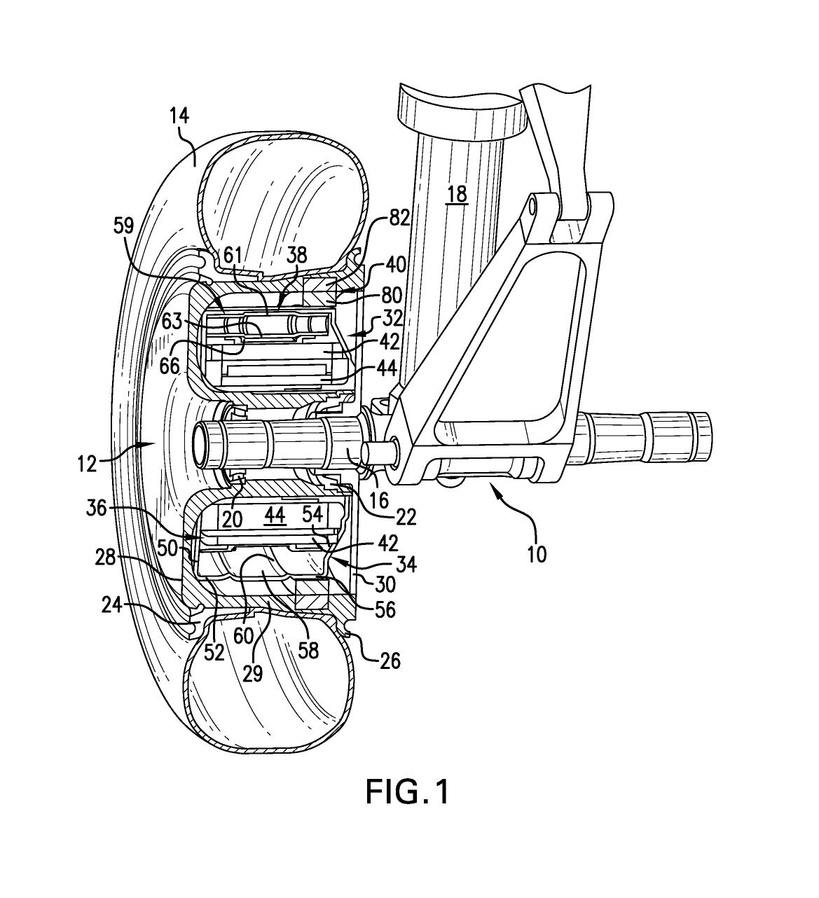

Referring to the drawings, FIG. 1 shows, in cross-sectional perspective view, a portion of an aircraft landing gear 10 and a landing gear wheel 12 with an aircraft drive wheel drive system including a roller traction drive system according to the present invention mounted within the landing gear wheel. Although only one landing gear wheel is shown in detail, it is contemplated that one or more nose landing gear wheels, one or more main landing gear wheels, or a combination of nose and main landing gear wheels could be equipped with drive wheel drive systems as described herein. In one possible arrangement, for example, equipping both wheels in a two-wheel nose landing gear with a drive wheel drive system provides the capability not only to effectively move the aircraft on the ground, but also to differentially steer and brake the aircraft by selective activation of the drive means of each wheel.

A tire 14 is shown mounted on the wheel 12. The wheel 12 and tire 14 are rotatably mounted on an axle 16 attached to the landing gear 10. The landing gear 10 includes a central piston 18 and other standard landing gear structures (not numbered) typically found in an aircraft nose or main wheel landing gear. The wheel 12 is rotatably supported on the axle 16 by support structures, such as the bearing arrangements 20 and 22 shown adjacent to the axle 16. Other suitable support structures or bearings could also be used for this purpose. The wheel 12 preferably has the two part configuration shown in FIG. 1, although other wheel designs could also be employed.

Removal and remounting of the tire 12 is facilitated by providing a demountable tire flange 24 on an outboard side of the wheel 12 that can be removed when necessary. The demountable flange could also be located on the inboard side of the wheel. A stationary tire flange 26, shown here on the inboard side of the wheel, is provided to hold an opposite side of the tire 14. The stationary tire flange is integrally formed with a portion 29 of a substantially “C”-shaped outboard wheel wall section 28 that forms most of the wheel. A smaller inboard wheel wall section 30 connects to the outboard wheel section 28 to define a maximum space or volume within the wheel 12 where the roller traction drive system of the present invention can be mounted integrally with the other components of the aircraft drive wheel drive system. To provide a clearer view of the main components of the drive wheel drive system, elements, such as, for example, the tire valve stem, are not shown.

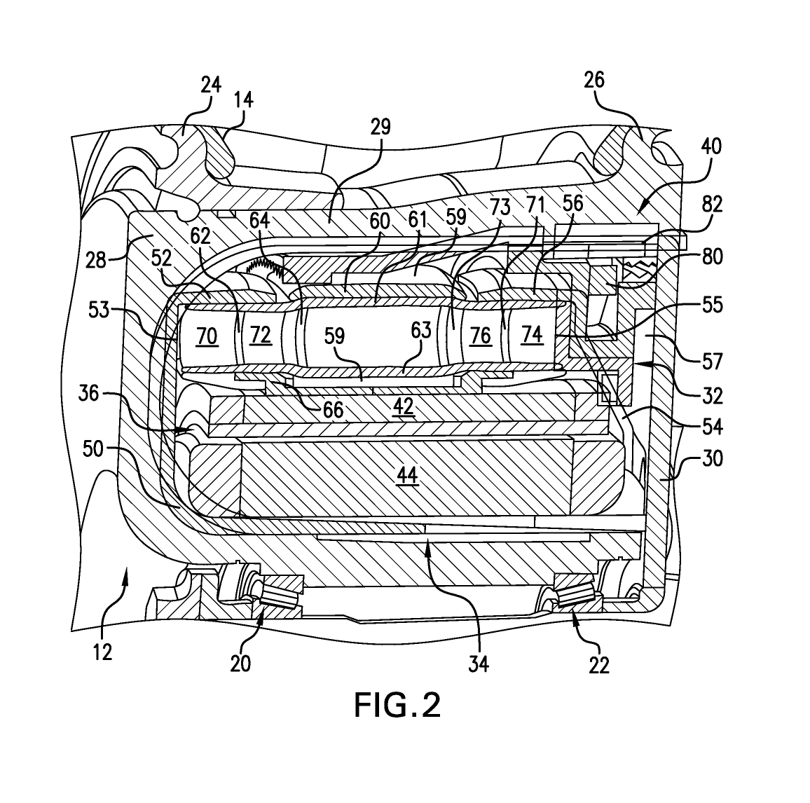

A preferred configuration and arrangement of components of the aircraft drive wheel drive system 32 is shown in FIGS. 1 and 2. Other functionally equivalent arrangements and configurations are also contemplated to be within the scope of the present invention. In the preferred configuration shown, the components of the drive system 32 may be enclosed within a system housing 34 that is shaped to fit completely within the space created by the arrangement of the respective outboard and inboard wall sections 28 and 30 of the wheel 12. The main elements of the drive wheel drive system include a roller traction drive system 38 functionally disposed to transfer torque between a non-engine drive means 36 and a clutch assembly 40, preferably relatively positioned as shown in FIGS. 1 and 2. In a preferred arrangement, the components of the drive means 36 and the roller traction drive system 38 are not centered within the wheel space, but may be positioned within the system housing 34 so that the outboard edges of these structures are in substantially parallel alignment with the outboard wheel wall 28. As a result, the system housing 34 may have the asymmetrical configuration shown.

A preferred non-engine drive means 36 may include a rotating element, such as a rotor 42, and a stationary element, such as a stator 44. The rotor 42 is preferably located externally of the stator 44, as shown, but other drive means component arrangements could also be used and are contemplated to be within the scope of the present invention. For example, the positions of the rotor 42 and stator 44 could be reversed so that the rotor is internal to the stator.

A non-engine drive means 36 preferred for use with the aircraft drive wheel drive system of the present invention may be an electric motor assembly that is capable of operating at high speed and could be any one of a number of suitable designs. An exemplary drive means is an inside-out electric motor in which the rotor can be internal to or external to the stator, such as that shown and described in U.S. Patent Application Publication No. 2006/0273686, the disclosure of which is incorporated herein by reference. A range of motor designs capable of high torque operation across a desired speed range capable of moving an aircraft wheel and functioning as described herein may also be suitable non-engine drive means in an aircraft drive wheel drive system. A high phase order electric motor of the kind described in, for example, U.S. Pat. Nos. 6,657,334; 6,838,791; 7,116,019; and 7,469,858, the disclosures of the aforementioned patents are incorporated herein by reference, can be effectively used as a drive means 36. Another example of a suitable drive means 36 is a high phase order induction motor with a top tangential speed of about 15,000 linear feet per minute and a maximum rotor speed of about 7200 rpm, although drive means capable of a wide range of such speeds could also be used. Other non-engine drive means, including hydraulic and/or pneumatic drive means, are also contemplated to be within the scope of the present invention.

The system housing 34 is specifically designed to operatively and integrally enclose the non-engine drive means 36 and the roller traction drive system 38, as well as to operatively support the clutch assembly 40 as it is controlled to engage and disengage the roller traction drive system. FIG. 2 shows these structures in greater detail than they appear in FIG. 1. The system housing may completely enclose the aircraft drive wheel drive system components and support them completely within the space available in an aircraft drive wheel. The preferred system housing 34 shown in FIG. 2 may be formed in sections to include an outboard section 50 that extends from the stationary element 44 of the drive means substantially parallel to the wheel wall 28 toward the wheel section 29 to form an outboard lip 52 that contacts and wraps around an outboard end 53 of the roller traction drive system 38. An inboard section 54 of the motor housing 34 may be angled from the stationary element 44 toward the horizontal upper wheel section 29 to form an inboard lip 56 that contacts and wraps around an inboard end 55 of the roller traction drive system 38. The inboard lip 56 is interposed between an outer surface of the roller traction drive inboard end 55 and the clutch assembly 40. A circumferential central system housing section 58 may be disposed between the housing outboard lip 52 and inboard lip 56 to contact an output surface 59 of the roller traction drive system.

The roller traction drive system 38, which is operatively positioned between the non-engine drive means 36 and the system housing sections 52, 56, and 58, is not shown in the lower part of the wheel 12 in FIG. 1, providing a clearer view of the preferred three part arrangement of the system housing sections. It will be noted that circumferential gaps 60 may be provided between the central circumferential section 58 and the outboard and inboard lip portions 52 and 56 of the system housing.

As discussed above, the inboard section 54 of the system housing may be angled to correspond to the asymmetric shape of the nonparallel inboard edges of the drive means elements 42 and 44 and the roller traction drive system 38, which provides an inboard recess 57 between the system housing wall 54 and the inboard wheel wall 30. The recess 57 may be used, for example, to accommodate clutch assembly components. The inboard system housing section 54 and recess 57 could also direct and receive wiring (not shown) from the drive means elements, sensors, and/or other components that must be attached to wiring. This wiring may be a wire harness or other convenient wiring arrangement that ultimately connects the drive system components to the aircraft electrical system and/or a source of electrical power.

The roller traction drive system 38 is a system that performs essentially the same functions that would be performed by gearing or a gear system. The replacement of gearing by a roller traction drive system in an aircraft drive wheel drive system presents many advantages. A roller traction drive system designed to actuate a non-engine drive means capable of moving a commercial sized aircraft on the ground not only has a low profile and is light weight, but also provides the high torque and high speed change ratio required to optimally operate the drive means to move an aircraft on the ground. Unlike a gear system, a roller traction drive system has substantially zero backlash and can be made of dry running components that do not require lubrication. Planetary and other gear systems are capable of only limited gear ratios, while an infinite gear ratio is possible with a preferred roller traction drive system. A roller traction drive system preferred for the present aircraft drive wheel system may be, in addition, self-energizing, as will be discussed below. Other advantages of integrating a roller traction drive system with an aircraft drive wheel non-engine drive means to drive an aircraft wheel and move an aircraft on the ground can also be realized.

A clutch assembly 40 is provided in the aircraft drive wheel drive system of the present invention that can be activated automatically or manually to engage and disengage the roller traction drive system into and out of actuation with the non-engine drive means so that the drive means is actuated to move an aircraft wheel to drive an aircraft on the ground or, when appropriate, de-actuated so that the drive means is unable to drive the aircraft wheel. The roller traction drive system 38 should only be engaged by the clutch assembly 40 to actuate the drive means when the aircraft is actually on the ground, such as after landing and prior to takeoff, and when the aircraft is traveling at a desired speed during ground travel. The present aircraft drive wheel drive system preferably includes one or more failsafe mechanisms (not shown) that prevent the clutch assembly from engaging the roller traction drive system when the aircraft landing gear wheels are not supporting the aircraft on the ground, such as, for example, when the aircraft is in flight and at other times when an aircraft landing gear wheel should not be driven.

The clutch assembly 40 may be located in an inboard portion of an aircraft wheel, such as adjacent to the system housing inboard lip section 56 as shown in FIGS. 1 and 2, although other locations may also be used. The clutch assembly 40 should be operably positioned to move into and out of engaging contact with the roller traction drive system 38. The clutch assembly may preferably include both automatic and manual or override clutch control means (not shown) to control operation of the clutch to engage or disengage the roller traction drive system. A fully automatic clutch control means (not shown) programmed to engage or disengage the clutch from the roller traction drive system with an automatic or manual override feature is preferred. A circumferential clutch assembly recess 82, configured to receive a circumferential clutch element 80, may be provided in the wheel portion 29. When the roller traction drive system is disengaged, the clutch control means may move the clutch element into the recess 82 or otherwise ensure that the clutch element 80 is out of engaging contact with the roller traction drive system 38 so that the rolling traction drive system cannot actuate the non-engine drive means 36. During engagement, the clutch assembly 40 is moved into engaging contact with the roller traction drive 38. The clutch assembly clutch element 80 could be one of a number of clutch designs suitable for the purpose described.

A roller traction drive system 38 preferred for use in the aircraft drive wheel system of the present invention may employ a series of substantially cylindrical rollers, preferably arranged in two rows and positioned within opposed motive surfaces or “races,” so that a respective inner or outer row of rollers contacts an inner or outer race. The rollers, which are preferably hollow cylinders, contact the motive surfaces with pure rolling contact and low friction and, therefore, are highly efficient. Rollers have been found to function more efficiently than balls in a traction drive structure. Rollers, particularly hollow cylindrical rollers, do not demonstrate the high levels of friction and/or wear that characterizes gears used to drive a motor or other drive means. In addition, traction and rigidity of a roller traction drive system may be varied as the number of rollers in a roller traction drive is varied, with increased numbers of rollers increasing traction and rigidity.

Optimally, a preferred roller traction drive system suitable for use with the present aircraft drive wheel drive system should achieve torque in the range of at least about 3000 foot pounds (ft-lbs) and should achieve at least about 10,000 revolutions per minute (rpm) during operation (and preferably higher), with a reduction ratio of at least about 30:1. Operation of the present roller traction drive system should preferably maintain stresses on the material selected for the rollers and the races below the endurance limit of the selected materials for at least about 5000 hours of use. Traction pressure must also be kept below roller and race material endurance limits. During high speed operation of the present roller traction drive, moreover, a drive means rotor must be kept in alignment and at a reliably consistent radial distance with respect to the traction roller drive. Additional parameters that maximize the service life and safety of a roller traction drive as it operates in conjunction with a non-engine drive means as described herein to move an aircraft autonomously on the ground may also be important considerations and are contemplated to be within the scope of the present invention.

A range of different configurations of roller traction drive systems that satisfies the parameters described above could be used to actuate a non-engine drive means in an aircraft drive wheel to move the aircraft effectively and efficiently during ground operations. An optimum number and arrangement of preferably hollow cylindrical rollers capable of self-centering and maintaining alignment is provided in a preferred roller traction drive system. Specific centering and alignment structure could also be added to the rollers and/or adjacent or associated structures. The cylindrical roller shape permits the maintenance of cylindrical line contact for maximum traction and load distribution. The multiple load sharing contacts possible with this preferred arrangement allow the production of high torque when the roller traction drive system 38 is engaged. Torque is transmitted from the roller traction drive system 38 to the non-engine drive means 36 through rolling friction, which is approximately equal to the applied torque. The number of rollers can be varied, depending on the desired torque output of the roller traction drive. When the number of rollers is increased, the number of traction contacts and, thus, the traction force is increased. An accompanying increase in high speed change ratios and consistent force distribution can also be realized when the number of rollers is increased. The extent to which the system is preloaded can also affect torque traction force produced by the system.

One roller traction drive system 38 particularly preferred for use in the aircraft drive wheel drive system of the present invention includes a roller box 59 with an outer motive surface 61 positioned adjacent to the system housing sections 52, 56, and 58. An inner motive surface 63 of the roller box 59 is supported by a support element 66 adjacent to and in engaging contact with the rotor element 42 of the drive means. The support 66 enables transmission of torque from the roller traction drive system to the drive means rotor element to change the speed of the rotor element as necessary. The support element 66 may be configured so that it additionally functions as a bearing for the drive means 36.

A plurality of rollers, which, as noted above, are preferably hollow cylinders and can be varied in number, are arranged within the space between an outer race 62 and an inner race 64. In one preferred arrangement of rollers, rows of outer rollers 70 and 72 are positioned within the outboard space between the races 62 and 64 adjacent to the roller traction drive outboard end 53. Rows of inner rollers 74 and 76 are similarly positioned with respect to the races 71 and 73 and the roller traction drive inboard end 55.

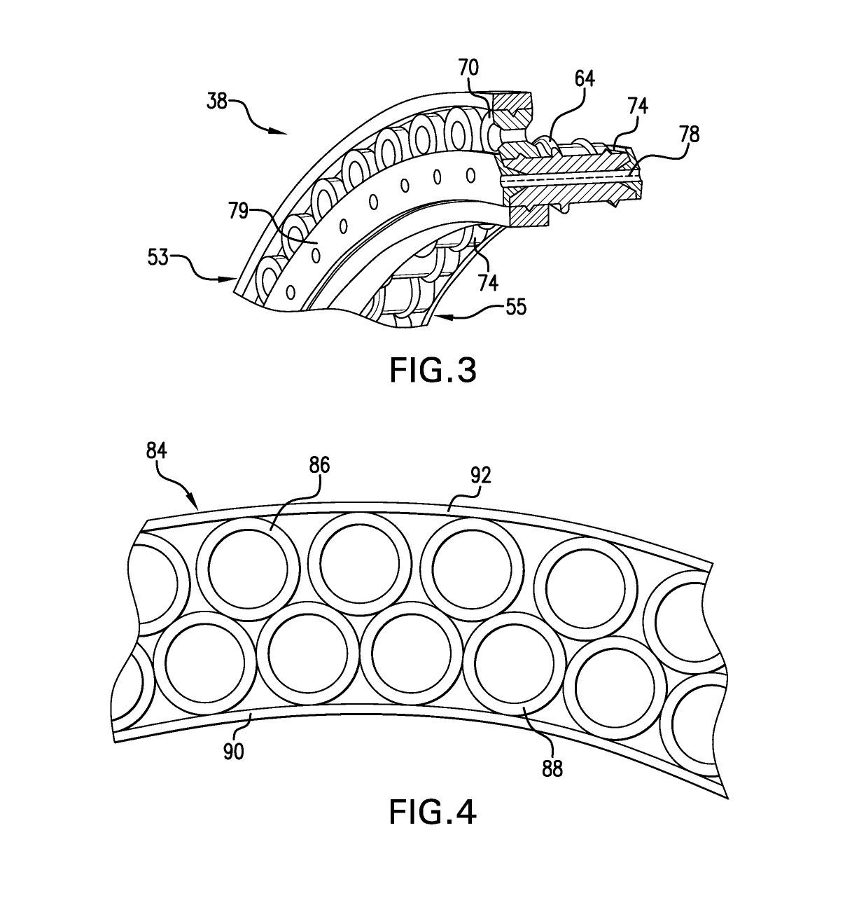

FIG. 3 shows a perspective view of one possible arrangement of rollers supported between races within a roller box 59 in a roller traction drive system 38 that may be used to actuate a non-engine drive means 36 in an aircraft drive wheel in accordance with the present invention. The drawings are not drawn to scale, and all of the rollers and races are not labeled in FIG. 3. In this design, structure may be provided to enable the rollers to track straight and true without the application of external force. For example, an array of spaced pins 78 is provided to ensure proper roller spacing, and a cage structure 79 helps to maintain roller alignment. The rollers are preferably also configured to be self-centering and are maintained centered and in alignment as the rollers 70, 72, 74, and 76 rotate during rotation of the roller traction drive with the rotor element 42. Higher reduction ratios can be achieved with this arrangement than, for example, with roller systems that use ball bearings. Because the system is self-energizing, increased efficiencies and loads are possible. As discussed herein, traction can be varied by varying the numbers of rollers and the materials from which the rollers and races are formed.

FIG. 4 is a diagrammatic end view of another arrangement of rollers in a roller box 84 for a roller traction drive system 38 in accordance with the present invention. In this arrangement, two rows of rollers 86 and 88 are positioned between an inner race 90 and an outer race 92. FIGS. 3 and 4 illustrate possible arrangements of rollers, races, with and without alignment structures. Other configurations of rollers and additional elements that maintain accurate roller alignment during operation of the roller traction drive could also be used and are contemplated to be within the scope of the present invention.

The self-energizing feature of the present roller traction drive system requires the maintenance of an optimum coefficient of friction (CF) and traction angle between the rollers (70, 72, 74, and 76 or 86 and 88) and the race or motive surface (62, 64 and 90, 92) contacted by the rollers. Since an inner circumferential race will have a smaller diameter than an outer circumferential race, the traction angle of a roller, such as rollers 88, contacting an inner race, such as race 90, is generally lower than the traction angle of a roller, such as rollers 86, contacting an outer race, such as race 92. In addition, rollers with different diameters will have different traction angles. A minimum CF is required between contacting rows of rollers in a torque transmitting set. A self-energizing effect has been found to occur when the CF is similar between contacting rollers, such as between rollers 86 and 88, and between rollers and races, such as between rollers 70 and race 62. To illustrate, ensuring that one type of roller traction drive system useful with the present invention is self-energizing under load, a minimum traction angle in the range of about 17 to about 19 degrees and a CF of at least about 0.4 are desired. A lower CF, in the range of about 0.3 or less, might be more effective in some situations. Other traction angles and CF values may be more effective for self-energizing under load in roller traction drive systems that are also suitable for use with the present drive wheel system. A range of traction angles and CF values useful to produce a self-energizing roller traction drive is contemplated to be within the scope of the present invention.

The production of a self-energizing roller traction drive may be achieved by the selection of specific materials for the rollers and races that have a desired CF. The materials from which the rollers and races are formed may be selected to vary the coefficient of friction (CF), which influences rotation of the rollers and operation of the roller traction drive. There are many possible combinations of materials that can be used to form the rollers and the races to achieve coefficients of friction (CF) in the ranges desired and the degree of rolling contact desired for optimum roller traction drive performance. In some applications, it may be desirable to reduce CF with increased contact load, which may also be achieved by the selection of specific materials for the rollers and races that will achieve this objective. Additionally, because a roller traction drive system 38 requires a defined amount of preload to transfer torque, a combination of materials may be selected that can prevent this preload from being lost. The materials selected must also be able to maintain a desired optimum preload as thermal expansion of roller traction drive components occurs during operation of the aircraft drive wheel drive system. Preferred materials allow the use of dry running components, eliminating the need for lubrication during operation, which lengthens the service life of the rollers, races, and other components of the roller traction drive system.

Materials that may be used to form rollers, races, and other roller traction drive system components to accomplish the objectives described above include titanium, various kinds of steel, beryllium copper alloys, and spinodal bronzes, which are copper-nickel-tin alloys. Other suitable materials that enable the components of the present roller traction drive system to achieve the functions required in an aircraft drive wheel environment are also contemplated to be within the scope of the present invention.

Titanium provides high strength, light weight, and a relatively high CF. The wide array of different kinds of steel available provides a plethora of choices that enable construction of roller traction drive components with optimal thermal expansion, coefficient of friction, and other desired characteristics for a roller traction drive system functioning in an aircraft drive wheel environment. A chrome-plated steel, such as, for example without limitation, 4340 steel, may be used effectively in a roller traction drive system for an aircraft drive wheel drive system. Suitable beryllium copper alloys are available from Materion and other sources. Spinodal bronze alloys, for example those available as the ToughMet series of alloys from Materion and from other sources, can be used interchangeably with beryllium copper in many applications. The high strength, hardness, toughness, and corrosion resistance of spinodal bronze alloys, as well as their desirable anti-friction properties under severe loading conditions, make them well suited for roller traction drive system components.

The CF of beryllium copper is high when it contacts steel in a lubrication-free environment, but has a low CF when beryllium copper contacts itself. Contacts that produce traction are beryllium copper against steel, while contacts that require a low CF are beryllium copper against beryllium copper.

One possible combination of materials of rollers and races, such as those shown in FIG. 4, for example, could be a beryllium copper inner race 90, steel rollers 88, beryllium copper rollers 86, and a steel outer race 92. Another possible combination would be a steel inner race 90, beryllium copper rollers 88, steel rollers 86, and a beryllium copper outer race 92. An additional possible configuration of a roller traction drive system 38 in accordance with the present invention may include a spinodal bronze inner race 90, steel rollers 88, spinodal bronze rollers 86, and a steel outer race 92. A further possible combination of materials in the present roller traction drive system 38 may include a steel inner race 90, spinodal bronze rollers 88, steel rollers 86, and a spinodal bronze outer race 92. The foregoing combinations are meant to be illustrative only, and many other possible combinations of the preferred materials and/or other materials are possible that provide the desired torque transfer and speed change from the roller traction drive system 38 to a non-engine drive means 36 while controlling the effects of undesirable thermal expansion during operation of an aircraft drive wheel to move an aircraft autonomously on the ground.

A major advantage achieved by an aircraft drive wheel drive system that includes a roller traction drive system to actuate a non-engine drive means as described herein is the significantly reduced heating that results. Heat tends to be evenly distributed in the design of the present drive system, and heat build-up is minimized by providing a heat dissipation path through the axle 16. Forming the components of the roller traction drive system 38 from materials that enhance heat dissipation and minimize thermal expansion also helps to maintain even heat distribution.

While the present invention has been described with respect to preferred embodiments, this is not intended to be limiting, and other arrangements and structures that perform the required functions are contemplated to be within the scope of the present invention.

### INDUSTRIAL APPLICABILITY

The roller traction drive system of the present invention is designed to find its primary applicability as an actuator of a non-engine drive means in an aircraft drive wheel drive system operable to drive an aircraft where it is desired to realize the benefits of moving an aircraft very efficiently on the ground without reliance on the aircraft's main engines or external ground vehicles.

1. A roller traction drive system operatively integral with an aircraft drive wheel drive system designed to efficiently move an aircraft autonomously during ground operations comprising:
a. at least one drive wheel rotatably mounted on an aircraft nose or main landing gear to move an aircraft autonomously during ground travel without reliance on aircraft engines or external vehicles; and
b. a drive wheel drive system mounted completely within and operably connected to said drive wheel to control rotation of said drive wheel, wherein said drive wheel drive system comprises non-engine drive means in driving contact with said drive wheel to power rotation of said drive wheel at a desired speed and torque, a roller traction drive system in actuating contact with said non-engine drive means, and a clutch assembly controllable to selectively engage and disengage said roller traction drive system into and out of said actuating contact with said non-engine drive means, wherein said roller traction drive system comprises a plurality of rollers in rolling traction force contact between spaced circumferential races, and wherein each of said rollers and said races is formed of a material selected to establish and maintain effective torque transfer between said rollers and said races and with said non-engine drive means.

2. The drive system of claim 1, wherein said roller traction drive system further comprises a roller box housing said rollers and races operably interposed in torque transfer relationship between said clutch assembly and said non-engine drive means.

3. The drive system of claim 1, wherein said races comprise an inner circumferential race and an outer circumferential race spaced outwardly of said inner circumferential race, and said plurality of rollers comprises a circumferential row of inner rollers in contact with said inner race and a circumferential row of outer rollers in contact with said inner rollers and said outer circumferential race.

4. The drive system of claim 3, wherein said inner race and said outer rollers are made of a first material and said inner rollers and said outer race are made of a second material different from said first material.

5. The drive system of claim 4, wherein said first material comprises beryllium copper and said second material comprises a steel alloy.

6. The drive system of claim 4, wherein said first material comprises steel and said second material comprises beryllium copper.

7. The drive system of claim 4, wherein said first material comprises a spinodal bronze alloy and said second material comprises steel.

8. The drive system of claim 4, wherein said first material comprises steel and said second material comprises a spinodal bronze alloy.

9. The drive system of claim 1, wherein each of said rollers and said races are formed from a material selected from the group comprising titanium, steel alloys, beryllium copper, and spinodal bronze alloys.

10. The drive system of claim 1, wherein said non-engine drive means comprises an electric, pneumatic, or hydraulic motor.

11. The drive system of claim 10, wherein said non-engine drive means comprises a high phase order electric motor in actuating contact with said roller traction drive system.

12. The drive system of claim 2, wherein said roller box comprises a drive means support adapted to provide a bearing connection between said non-engine drive means and said roller traction drive system.

13. The drive system of claim 1, wherein said rollers comprise hollow cylindrical structures.

14. The drive system of claim 1, wherein said rollers are sized and positioned between said races to produce a desired torque and frictional contact between said rollers and between said rollers and said races when said roller fraction drive system is engaged to actuate said non-engine drive means.

15. The drive system of claim 14, wherein said plurality of rollers comprises a circumferential array of outboard rollers located near an outboard edge of said roller traction drive system and a circumferential array of inboard rollers located near an inboard edge of said roller fraction drive system.

16. The drive system of claim 15, wherein each of said outboard and said inboard array of rollers comprises a double row of rollers comprising an inner row and an outer row; positioned to maintain a desired optimum fraction angle and formed of a material selected to establish and maintain effective torque transfer contact during operation of said drive wheel drive system to move an aircraft autonomously on the ground.

17. The system of claim 16, wherein said races and said rollers are made of materials selected from the group comprising titanium, steel alloys, beryllium copper, and spinodal bronze alloys, wherein materials forming said races or said rollers are selected to produce a desired coefficient of friction when said rollers are positioned to maintain said desired traction angle, thereby self-energizing said roller fraction drive system.

18. A roller traction drive system actuatable to transfer torque to a non-engine drive motor activatable by said roller traction drive system to move a nose or main landing gear wheel to drive an aircraft autonomously during ground operations, wherein said roller traction drive system comprises at least an inner array of cylindrical rollers in contact with an outer array of cylindrical rollers, said inner array being in further contact with an inner race and said outer array being in further contact with an outer race, wherein said rollers and said races are made of materials selected to produce a desired coefficient of friction when said rollers are positioned to maintain a desired optimum traction angle during actuation of said roller drive system, and wherein said roller traction drive system is located in torque transfer and activating contact with said non-engine drive motor within said nose or main landing gear wheel.

19. The roller traction drive system of claim 18, wherein said materials are selected to have a desired coefficient of friction and are selected from the group comprising titanium, steel alloys, beryllium copper, and spinodal bronze alloys.

20. The roller traction drive system of claim 19, wherein said materials are further selected to dissipate heat from said roller traction drive system.

21. A roller fraction drive system operatively integral with an aircraft drive wheel drive system designed to efficiently move an aircraft autonomously during ground operations without reliance on aircraft engines or external tow vehicles comprising:
a. a roller traction drive system within a wheel drive system mounted completely within a drive system housing completely within at least one wheel rotatably mounted on an aircraft landing gear axle and operatively connected to said wheel to control rotation of said wheel to drive the aircraft during ground operations; and
b. said roller fraction drive system is positioned within said drive system housing in actuating and torque transfer between a drive motor and a clutch assembly controllable to selectively engage or disengage said roller fraction drive system into and out of torque transfer contact with said drive motor.

22. The system of claim 21, wherein said at least one wheel comprises an inboard wall section connected to an outboard wall section to define an maximum interior space within said wheel between said landing gear axle and a tire mounted on said wheel and said drive system housing has an outboard section configured to be parallel to said wheel outboard wall section, an angled inboard section spaced from said wheel inboard wall section to define an inboard recess within said interior space, and a central circumferential section disposed between said outboard section and said inboard section.

23. The system of claim 22, wherein an outboard extent of said drive motor is aligned with an outboard edge of said roller fraction drive system so that said outboard extent and said outboard edge are in parallel alignment with said wheel outboard section.

24. The system of claim 22, wherein said drive system housing further comprises support means for providing a bearing connection between said drive motor and said roller traction drive system.

25. The system of claim 21, wherein said roller fraction drive system comprises a roller drive housing supporting a plurality of hollow cylindrical rollers in rolling traction force contact with spaced circumferential races.

26. The system of claim 25, wherein said rollers are sized and positioned between said races to produce a desired torque and frictional contact between said rollers and between said rollers and said races when said roller traction drive means is engaged by said clutch assembly to actuate said drive motor.

27. The system of claim 25, wherein said rollers and said races are positioned within said roller drive housing so that said plurality of rollers comprises a circumferential array of outboard rollers located near an outboard edge of said roller drive housing and a circumferential array of inboard rollers located near an inboard edge of said roller drive housing.

28. The system of claim 27, wherein each of said circumferential array of outboard and said circumferential array of inboard rollers comprises a double row of rollers comprising an inner row and an outer row located in positions between said races to maintain a desired optimum traction angle and to energize said roller traction drive system.

29. The system of claim 28, wherein said races and said rollers are made of a material selected to produce a desired coefficient of friction when said rollers are positioned between said races to maintain said desired traction angle.

30. The system of claim 28, wherein said roller drive housing comprises a motive surface in torque transfer contact with said clutch assembly and an opposed motive surface in torque transfer contact with said drive motor.

31. The system of claim 28, wherein said rollers comprise self-alignment means for maintaining a desired rolling force contact between said rollers.

32. The system of claim 22, wherein said clutch assembly is positioned to be in selectively engaging contact with said roller traction drive system and said wheel comprises a clutch recess located in a wheel inboard wall section adjacent to said inboard section of said drive system housing to receive said clutch assembly when said clutch assembly is out of engaging contact with said roller traction drive system.
